(19) United States
(12) Patent Application Publication
(10) Pub. No.: US 2014/0229213 A1
(43) Pub. Date: Aug. 14, 2014

(54) AUTOMATED SYSTEM AND METHOD FOR JOB ESTIMATING, SCHEDULING AND ADMINISTRATION

(71) Applicant: Jivi Pty Ltd, Mooloolaba, QLD (AU)

(72) Inventors: Adam John Matthews, Pomona (AU); Jodi Emma Matthews, Pomona (AU)

(73) Assignee: Jivi Pty Ltd, Mooloolaba, QLD (AU)

(21) Appl. No.: 14/346,254

(22) PCT Filed: Sep. 20, 2012
(86) PCT No.: PCT/AU2012/001134

§ 371 Date: Mar. 20, 2014

(30) Foreign Application Priority Data
Sep. 20, 2011 (AU) 2011903869

(51) Int. Cl. G06Q 10/06; G06Q 30/06

(52) U.S. Cl. CPC G06Q 10/063114; G06Q 30/0611
USPC 705/7.15

(57) ABSTRACT

A method of estimating, scheduling and administrating a job including the steps of: receiving a location of a contractor; determining a status of the job according to the location of the contractor; sending to the contractor a prompt according to the status of the job; receiving a response to the prompt from the contractor and storing the response on a server; and sending the response to a customer for the job.

### FIELD OF THE INVENTION

This invention relates generally to an automated system and method for job estimating, scheduling and administration. In particular the invention allows a contractor to receive automated job notifications, provide estimates or quotes, and to schedule and invoice jobs using a wireless computing device such as a smartphone. In addition, notifications may automatically be sent to other parties associated with the job according to their respective role. The invention also automatically compiles bookkeeping information based on invoiced revenue and expense data.

### BACKGROUND OF THE INVENTION

Typically, when a customer requires a contractor, such as a plumber or an electrician, the customer often uses a business directory to locate suitable contractors. Once the customer has found a suitable contractor, the customer contacts the contractor to obtain a quote. Most customers obtain several quotes by telephoning several contractors. However, this process is time consuming for the customer, and inconvenient for many contractors, especially those that are sole traders.

In order to overcome some of, these problems, websites have been developed that allow a customer to obtain several quotes from a single source. The customer logs into a website and answers a series of questions to determine requirements of the job. The requirements of the job are then sent electronically, typically by email, to several contractors that then have an opportunity to provide a quote to the customer. The customer receives the quotes from the contractors and then contacts the preferred contractor or contractors to perform the job.

Although this process can be convenient for the customer, it can be difficult for small to medium sized contractors. The process is more advantageous to larger contractors who have personnel dedicated to administrative tasks such as providing quotations, and thus are able to provide quotations more quickly. Furthermore, larger contractors are able to invoice for the work performed more efficiently and thus achieve a well managed cash flow.

When scheduling jobs, a contractor may use a mapping tool to determine a required time to travel between two or more locations. Using this data in conjunction with an approximate time taken to perform a job, the contractor may draw up a schedule. However this process is also time consuming, and it can be difficult to make changes to the schedule as the schedule must be manually reconfigured.

Prior art systems exist that allow jobs to be scheduled based on a contractor's expertise and a priority or urgency of a job. In addition, systems exist that allow the jobs to be effectively scheduled according to a geographical region. Although such systems may be useful for larger contractors, such systems do not allow administration of jobs for use by sole traders or small contractors.

There is therefore a need for an improved system and method for job estimating, scheduling and administration.

The reference to any prior art in this specification is not, and should not be taken as, an acknowledgement or any form of suggestion that the prior art forms part of the common general knowledge, either in Australia or elsewhere.

### OBJECT OF THE INVENTION

It is an object of some embodiments of the present invention to provide consumers with improvements and advantages over the above described prior art, and/or overcome and alleviate one or more of the above described disadvantages of the prior art, and/or provide a useful commercial choice.

### SUMMARY OF THE INVENTION

In one form, although not necessarily the only or broadest form, the invention resides in a method of estimating, scheduling and administrating a job including the steps of:

receiving a location of a contractor;

determining a status of the job according to the location of the contractor;

sending to the contractor a prompt according to the status of the job;

receiving a response to the prompt from the contractor and storing the response on a server; and

sending the response to a customer for the job.

In another form, the invention resides in a system for estimating, scheduling and administrating a job including:

a server connected to the internet, the server including:

a memory coupled to a processor, wherein the memory includes computer readable program code components configured to cause:

receiving a location of a contractor;

determining a status of the job according to the location of the contractor;

sending to the contractor a prompt according to the status of the job;

receiving a response to the prompt from the contractor and storing the response on the server; and

sending the response to a customer for the job.

In yet another form, the invention resides in a mobile computing device for estimating, scheduling and administrating a job including:

a memory coupled to a processor, wherein the memory includes computer readable program code components configured to cause:

receiving a location of a contractor;

determining a status of the job according to the location of the contractor;

sending to the contractor a prompt according to the status of the job;

receiving a response to the prompt from the contractor and storing the response on a server or the mobile computing device; and

sending the response to a customer for the job.

Preferably, the status is one of a request for quotation or a live job, and the prompt is a prompt to complete a quote and a prompt to send an invoice, respectively.

Preferably, the prompt is sent from the server to the contractor when the contractor arrives at or near to the location.

Preferably, the location includes co-ordinates obtained from a. Global Positioning System (GPS).

Preferably, the location includes co-ordinates obtained by radio frequency triangulation including cellular triangulation.

Preferably, the location includes co-ordinates obtained by reference to available local short-range Wi-Fi networks.

Preferably, the location is displayed to the contractor on a map.

Preferably, the location is displayed according to the job status.

Preferably, the quote is completed from a template.

Preferably, the template is created by the contractor and stored on the server.

Preferably, the template is created with reference to information generated by the contractor and the customer and stored on the server.

Preferably, the quote includes a cost of one or more parts.

Preferably, the cost of the part is determined including the steps of:

receiving a description of the part;

sending the description of the part to a retailer;

receiving from the retailer a cost of the part; and

updating the quote with the cost of the part.

Preferably, the cost of the part is retrieved from a price list provided by a retailer. The price list may be stored on the server or locally on the mobile computing device or retrieved directly from the retailer in real time.

Preferably, a schedule of jobs is automatically created according to a time to perform the job and the location of the job, and the schedule is sent to the contractor.

Preferably, the schedule is displayed to the contractor on a map.

Preferably, the contractor is given a rating by the customer, and the rating for the contractor is stored in the database on the server.

### BRIEF DESCRIPTION OF THE DRAWINGS

An embodiment of the invention will be described with reference to the accompanying drawings in which:

FIG. 1 is a block diagram illustrating a system for job estimating and scheduling according to an embodiment of the present invention;

FIG. 2 is a flow diagram illustrating a method of job estimating and scheduling according to an embodiment of the present invention;

FIG. 3 is a screenshot of a contractor registration webpage according to an embodiment of the present invention;

FIG. 4 is a screenshot of a template webpage according to an embodiment of the present invention;

FIG. 5 is a screenshot of a second page of the template webpage of FIG. 4 according to an embodiment of the present invention;

FIG. 6 is a screenshot of a job status webpage according to an embodiment of the present invention;

FIG. 7 is a screenshot of a jobs webpage according to an embodiment of the present invention;

FIG. 8 is a screenshot of a quote template webpage according to an embodiment of the present invention;

FIG. 9 is a screenshot of a job recovery webpage according to an embodiment of the present invention;

FIG. 10 is a screenshot of a profit and loss webpage according to an embodiment of the present invention;

FIG. 11 is a screenshot of a scheduling webpage according to an embodiment of the present invention;

FIG. 12 is a screenshot of a home webpage according to an embodiment of the present invention;

FIG. 13 is a screenshot of a customer data webpage according to an embodiment of the present invention;

FIG. 14 is a screenshot of a search webpage according to an embodiment of the present invention;

FIG. 15 is a screenshot of a contractor search webpage according to an embodiment of the present invention;

FIG. 16 is a screenshot of a search results webpage according to an embodiment of the present invention;

FIG. 17 is a screenshot of a customer jobs webpage according to an embodiment of the present invention;

FIG. 18 is a screenshot of a quote review webpage according to an embodiment of the present invention;

FIG. 19 is a screenshot of a quote details webpage according to an embodiment of the present invention;

FIG. 20 is a screenshot of a previous contractors webpage according to an embodiment of the present invention;

FIG. 21 is a screenshot of a job overview webpage according to an embodiment of the present invention;

FIG. 22 is a screenshot of a quote prompt webpage according to an embodiment of the present invention;

FIG. 23 is a screenshot of a quote template webpage according to an embodiment of the present invention;

FIG. 24 is a screenshot of a parts webpage according to an embodiment of the present invention;

FIG. 25 is a screenshot of an invoice webpage according to an embodiment of the present invention;

FIG. 26 is a screenshot of a review invoice webpage according to an embodiment of the present invention;

FIG. 27 is a screenshot of a list of jobs for quoting webpage according to an embodiment of the present invention;

FIG. 28 is a screenshot of a list of live jobs according to an embodiment of the present invention; and

FIG. 29 is a screenshot of a job recovery webpage according to an embodiment of the present invention.

### DETAILED DESCRIPTION OF THE PREFERRED EMBODIMENT

Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element from another element without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention. It will be appreciated that the invention may be implemented in a variety of ways, and that this description is given by way of example only.

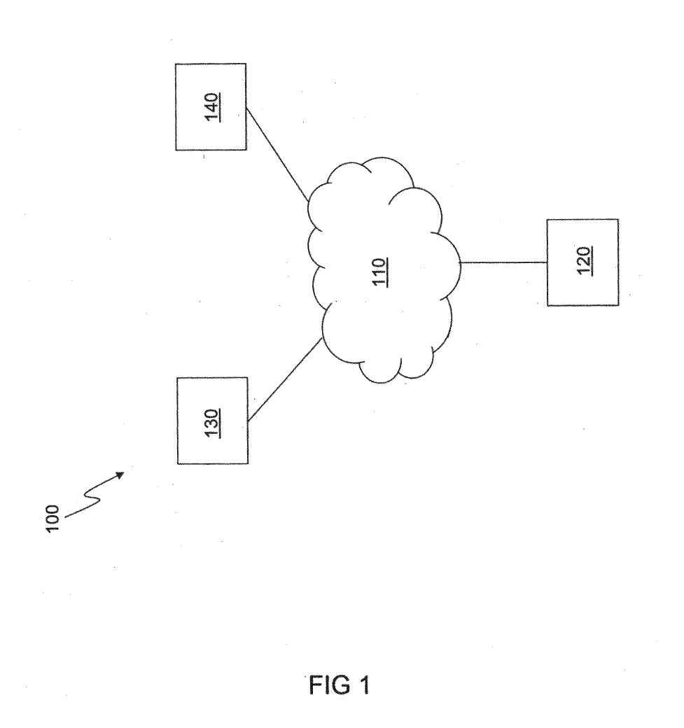

FIG. 1 is a block diagram showing a system 100 for job estimating and scheduling, according to some embodiments of the present invention. A computer in the form of a server 120 is connected to the Internet 110, to which users, such as a contractor 130 and a customer 140, have access. The users may access the server 120 using a web browser installed on a computer or a smartphone, or using an application installed on a smartphone or any other similar devices such as tablet computers and netbook computers. However the present invention is not limited to use on such devices.

The server 120 includes a memory coupled to a processor, and the memory includes computer readable program code components. The program code components are in the form of software installed on a computer readable medium, for example on a hard disk, a random access memory (RAM), or any other applicable computer readable medium. The program code components perform the method of the present invention.

Similarly, the present invention may be performed on a mobile computing device, such as a smartphone, the smartphone including computer readable program code components. A person skilled in the art will appreciate that the method of the present invention may be performed on any computing device such as the server 120 or the mobile computing device or both with data transferred between the server 120 and the mobile computing device.

The present invention allows a customer 140 looking for a contractor 130 for a service, such as a plumber, an electrician or a mowing service, to obtain several quotes by submitting a single set of details regarding a job into a web portal. The details of the job are received by each contractor 130. The contractor 130 may choose to prepare and send a quote to the customer 140. The customer 140 may review each quote received from each contractor 130 and choose to engage one of the contractors 130.

The invention also allows the contractor 130 to receive requests for quotation on a mobile or portable computing device such as a smartphone and complete and send a quote whilst the contractor 130 is at the job. In addition, the contractor 130 may also sub-contract components of the job. Thus any contractor 130 may use the system 100 to obtain quotations on a sub-contract basis' for components of the job which make up the contractor's quotation. Building contractors may therefore use the system to managesub-contracts.

When the contractor 130 arrives at a location of the job entered by the customer 140, the contractor 130 is automatically provided with a quote template with details of the job entered by the customer 140 requesting the quote. The contractor 130 is prompted by the smartphone to complete the quote. Once completed, the quote is sent to the customer 140 via the server 120. Furthermore, the present invention allows a contractor 130 to schedule jobs more efficiently.

If engaged, when the contractor 130 arrives at a job, the contractor 130 is prompted to send an invoice to the customer 140. Once the contractor 130 has completed the job or each component of the job, the contractor 130 sends the invoice using the smartphone. Someone familiar with the practice of job administration will also understand that a similar method can be used to collect other job-progress related administration data from site operatives to be provided to both the contractor's head office for review, and to the customer by way of job reports, progress reports or other job administration information (not shown in the current embodiment).

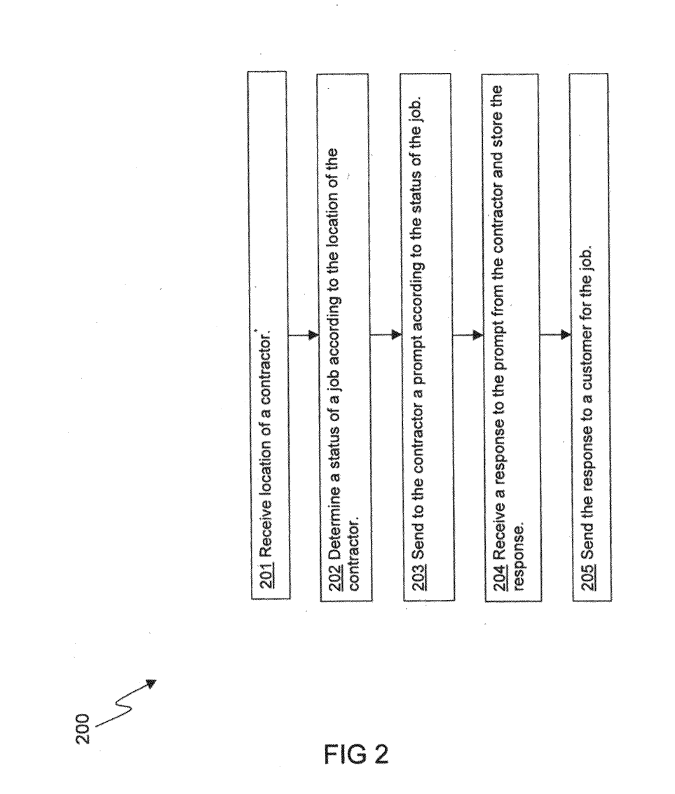

FIG. 2 shows a method of job estimating and scheduling according to an embodiment of the present invention. At step 201, a location of a contractor 130 is received. For example, the location may be an address, GPS co-ordinates received from the contractor's 130 smartphone or triangulation co-ordinates received from the smartphone. Furthermore, it should be appreciated that the location may be obtained by any other suitable means such as by reference to local area Wi-Fi networks.

At step 202 a status of the job is determined according to the location of the contractor 130. For example, if the contractor 130 has yet to complete a quote at the location, the status is a request for quotation. If the contractor 130 has completed the quotation and the contractor 130 is returning to the location to perform the job, the status of the job is live.

At step 203, a prompt is sent to the contractor 130 according to the status of the job. If the status is a request for quotation, the contractor 130 is prompted to prepare a quote. If the status is that the job is live, the contractor 130 is prompted to send an invoice to the customer 140.

At step 204, a response to the prompt from the contractor is received and the response is stored on the server and/or the smartphone. If the status is a request for quotation, the response is a quote. If the status of the job is live, the response is an invoice or other job progress data, as the case may be (not shown in the current embodiment). Finally, at step 205, the response, of either the quote or the invoice, is sent to the customer 140 for the job.

An advantage of the present invention is that the contractor 130 does not need to remember or look up a status of a job at a location or rely on a manual system such as a diary or written records of current jobs. Rather, when the contractor 130 arrives at the job location, the contractor 130 is automatically prompted by the smartphone to either complete a quote or complete an invoice according to the status of the job. Furthermore, all details of the job are also displayed according to the location of the contractor 130. This may include a list of job components or work items which together comprise the scope of the job. For example, if the contractor 130 has completed a quote and the customer 140 has engaged the contractor 130, when the contractor arrives at the location to do the job, the contractor 130 is prompted to send an invoice either for the complete job, or for components of the job which comprise the complete job. Furthermore, jobs may be efficiently scheduled according to location and a time taken to perform a job.

The present invention may also be used to notify relevant parties of the status of the job. This may be useful for managers of rented or leased accommodation for example. In one embodiment, a contractor 130 engaged to perform the job may enter details of the times and dates at which he or she intends to undertake the job at the property, by entering relevant data via a computer. The information may be transmitted, by email for example, to all relevant parties, (such as a property occupant, tenant or a property manager) based on preferences set by the customer or property manager in relation to the property (not shown in the current embodiment).

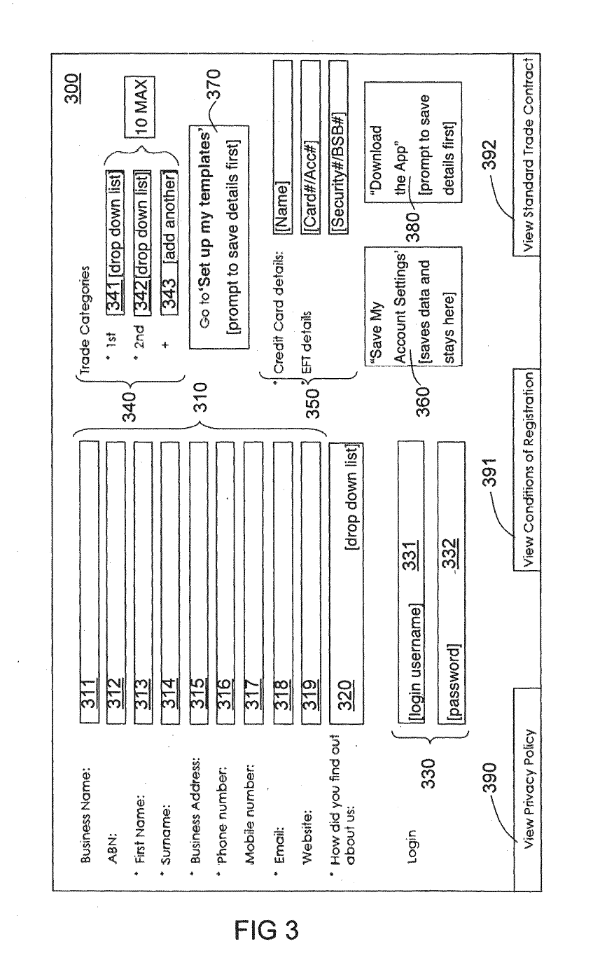

In order to use the system 100 of the present invention, the contractor 130 must register. FIG. 3 is a screenshot 300 of a contractor registration webpage according to an embodiment of the present invention. The contractor registration webpage allows a contractor 130 to register to use the system 100 of the present invention by providing business data.

The business data may include business details 310 such as a business name 311, a company number 312, a contact first name 313, a contact surname 314, an address 315, a phone number 316, a mobile phone number 317, an email address 318 and a website address 319. The business data may also include whether additional taxes or margins (such as Goods and Services Tax (GST) in Australia or Value Added Tax (VAT) in the United Kingdom) are applicable to the job performed by the contractor, and a total percentage of any such applicable taxes. The registration data may also include a feedback section 320 requesting feedback on how the contractor 130 heard about the website of the present invention. In addition, the contractor 130 selects and enters login details 330 such as a username 331 and password 332.

Next the contractor 130 selects a number of trade categories 340 relating to the service that the contractor 130 wishes to offer. The contractor 130 may select several trade categories 341, 342, 343 up to a limit, for example 10. The trade categories may be related, for example trades relating to gardening such as a mowing service, a lawn care service and a tree lopping service. Alternatively, the trade categories may be unrelated such as gardening services and vehicle mechanic services.

In order to use the service, a contractor 130 may pay a fee. In one embodiment, the fee is paid each time the contractor 130 is engaged to perform a job. However it should be appreciated that any other payment structure may be used, such as a percentage of successful quotes, or a monthly subscription fee. As such the contractor 130 may enter payment details 350 such as credit card details, or any other suitable payment method such as a direct bank transfer.

Once the contractor 130 has entered the business data, the contractor 130 may save the business data by clicking on a save data button 360 and the business data is transmitted to the server 120 and saved to a database on the server 120. The business data may also include templates, such as a quotation and an invoice template. By clicking on a template button 370 the contractor 130 may set up templates as described later. The contractor 130 may also download an application for running on a smartphone by clicking on an app button 380. In addition, the contractor 130 may obtain a privacy policy, terms and conditions, and a contract by clicking on a privacy button 390, a terms and conditions button 391 and a contract button 392 respectively as is known in the art.

When the contractor 130 clicks on the template button 370, the contractor 130 is presented with a template webpage.

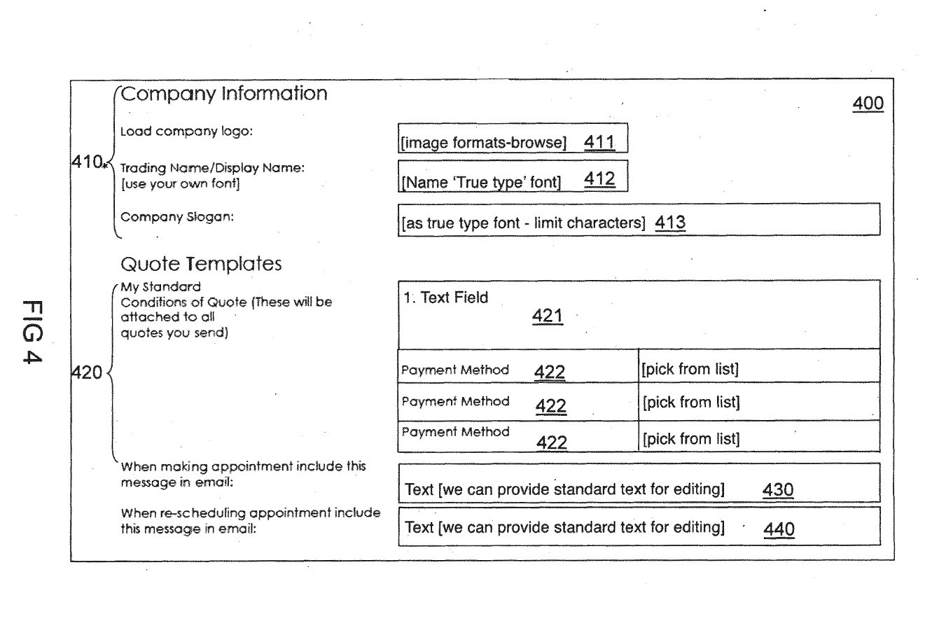

FIG. 4 is a screenshot 400 of a template webpage according to an embodiment of the present invention. The template webpage allows a contractor 130 to provide template data for quotations and invoices. Furthermore, the templates may include standard wording for including in emails sent to the customer 140.

The template data may include company information 410 such as a logo 411, a company name 412 and a company slogan 413. Quote template information 420 may include a standard text field 421 and a plurality of payment method options 422. Furthermore, the template data may also include standard text for including in an email such as when making an appointment 430 and when re-scheduling an appointment 440. The template data may also include a plurality of standard template layouts and designs from which the contractor 130 may select. Once the template data has been entered it is saved in a database on the server 120.

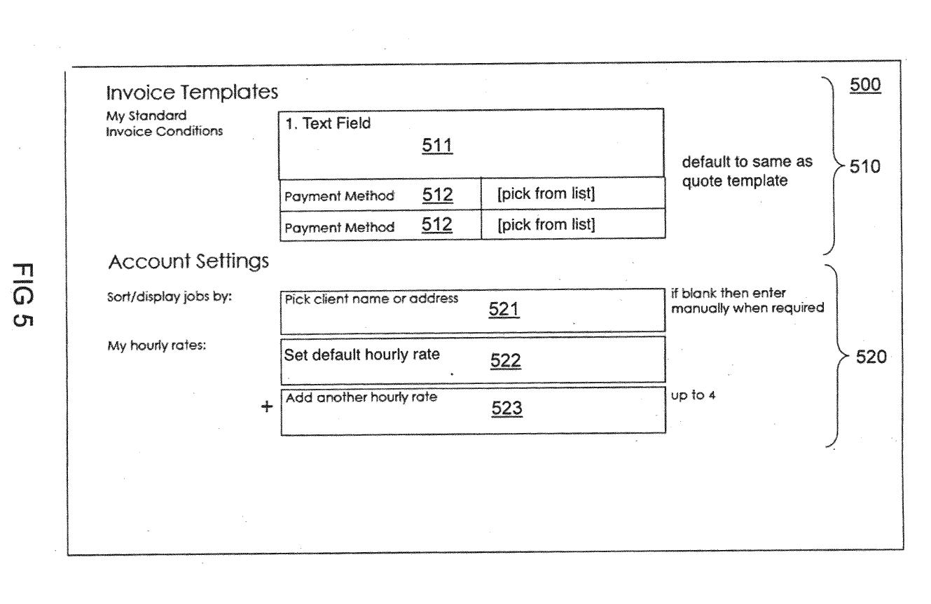

FIG. 5 is a screenshot 500 of a second page of the template webpage of FIG. 4 according to an embodiment of the present invention. The second page of the template webpage allows a contractor 130 to add further template data and may, include invoice data 510 including invoice text 511 and a plurality of payment methods 512. In one embodiment, the plurality of payment methods defaults to the same payment methods provided in the quote template information 420. The invoice text 511 may include standard text to be provided on the invoice.

In addition, template data may include account settings 520 such as selecting a default display method 521, a default hourly rate 522 and optionally further hourly rate(s) 523. As previously mentioned, the template data may also include a plurality of standard template layouts and designs from which the contractor 130 may select. The contractor 130 may also enter details (such as applicable postcodes) of region(s) or geographical areas in which the contractor 130 operates. Once the contractor 130 has entered the template data, the template data is transmitted to the server 120 and saved in a database on the server 120.

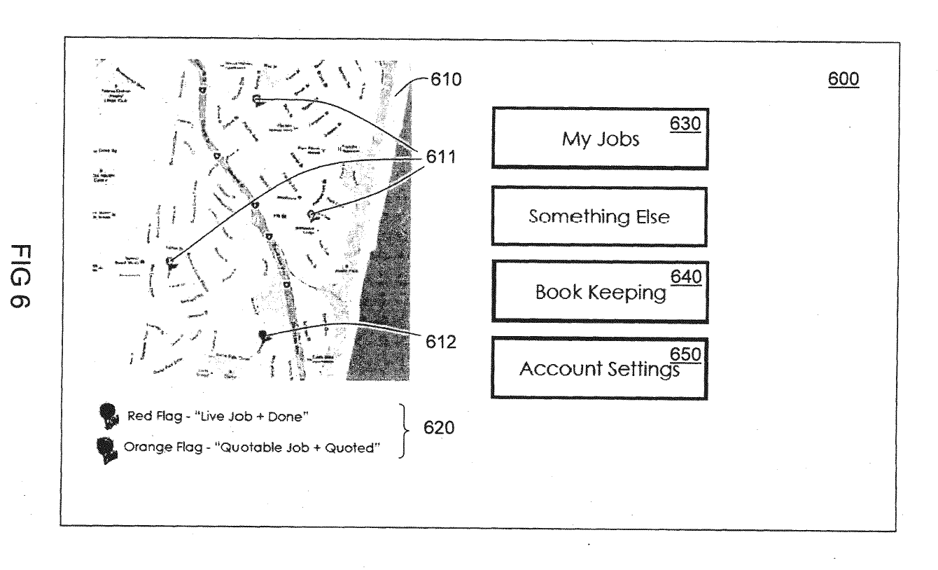

The system 100 also allows the contractor 130 to view current jobs on a map according to the location and the status of the job. FIG. 6 is a screenshot 600 of a job status webpage according to an embodiment of the present invention. The job status webpage shows a map 610, the map 610 including a plurality of markers 611, 612 according to the job status. In one embodiment, orange markers 611 show that the job requires quoting or has been quoted. Red markers 612 show that the job is live or has been completed. It should be appreciated that any suitable markers/colour may be used. Furthermore, each status may be listed individually rather than grouping jobs to be quoted and quoted jobs together, and live jobs and completed jobs together. In addition, the webpage includes a legend 620 of the markers 611, 612.

From the job status webpage, the contractor 130 may view a list of current jobs by clicking on a jobs button 630, view a bookkeeping webpage by clicking on bookkeeping button 640 or view account settings by clicking on an account settings button 650.

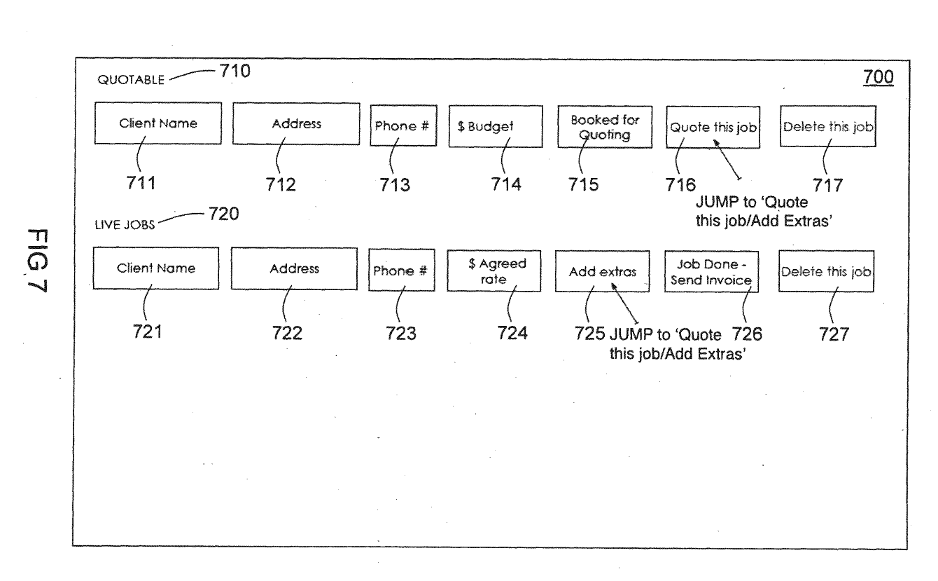

When the jobs button 630 of FIG. 6 is pressed, the contractor 130 is presented with a jobs webpage. FIG. 7 is a screenshot 700 of a jobs webpage according to an embodiment of the present invention. As shown in FIG. 7, the jobs webpage may include a list of quotable jobs 710 and a list of live jobs 720. The list of quotable jobs 710 are requests for quotation received from customer(s) 140 which have yet to be quoted. The list of live jobs 720 are jobs that the contractor 130 has been engaged to complete.

It should also be appreciated that the contractor 130 may manually add quotes by entering customer 140 and job details directly, rather than the details being received from a request for quotation.

The list of quotable jobs 710 may show details of each job such as a customer name 711, a customer address 712, a customer phone number 713, a budget for the job 714, the frequency of the job (for recurring jobs) and a job status 715. In addition, the contractor 130 may click on a quote button 716 to prepare a quote of the job, or delete the job by clicking on a delete button 717.

Similarly to the list of quotable jobs 710, the list of live jobs 720 may include a customer name 721, a customer address 722 and a customer phone number 723. In addition the list of live jobs 720 may include an agreed rate 724 for the job, a frequency of the job (for recurring jobs—not shown), an extras button 725 and a delete job button 727. The extras button 725, allows the contractor 130 to modify a quote in order to add additional items that the customer 130 may have requested, either prior to completing the job, or whilst the job is live. Furthermore, the contractor 130 may send an invoice if the contractor 130 has completed the job by clicking on a job done button 726.

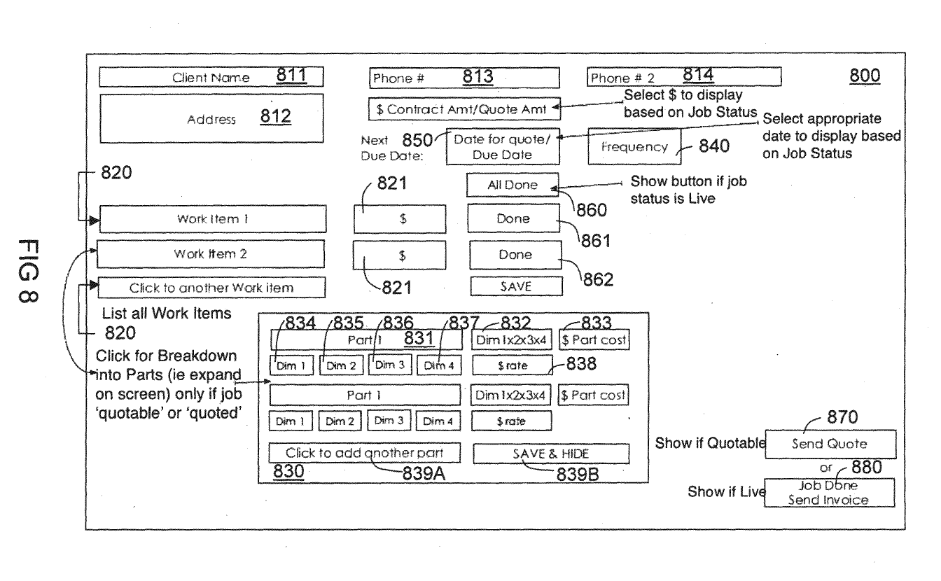

When the quote button 716, or the extras button 725 of FIG. 7 is pressed, the contractor 130 may complete a quote template for the job, as shown in FIG. 8. FIG. 8 is a screenshot 800 of a quote template webpage according to an embodiment of the present invention.

In order to complete a quote, the contractor 130 may enter a customer name 811, a customer address 812, and one or more phone numbers 813, 814. The contractor 130 may then enter one or more work items 820 required to do the job. For example, the work items 820 may be to “mow lawn” and “trim edges”. The contractor 130 may enter a price 821 for each item 820. Alternatively, the contractor 130 may enter a size of lawn to be mowed for example, and the system 100 may calculate the price 821 based on a size of lawn. In calculating the price 821, the system 100 may take into account the time required to mow the lawn and waste disposal costs.

For each work item 820 the contractor 130 may cost parts or subcontractors required for the job. For example, the contractor 130 may require gyprock in order to build a partition wall. In order to cost parts required for a job, the contractor 130 clicks on an applicable work item 820 in order to display a parts popup window 830. The contractor 130 then enters a description of a part 831, a unit of measurement for the part (not shown), a total dimension 832 of the part, a part cost 833, a first dimension 834, a second dimension 835, a third dimension 836, a fourth dimension 837 and a rate 838. From the dimensions 834, 835, 836, 837, the server 120 or the smartphone may determine the total dimension 832. In one embodiment, the part may be costed according to an area. For example the unit of measurement may be in metres squared and only the first and second dimensions 834, 835 need to be entered and the third and fourth dimensions 836, 837 default to 1. From the area, the server 120 (or the smartphone) may calculate a cost of the gyprock according to an area that is required. The rate 838 may be a cost per hour should a subcontractor be required. A person skilled in the art will realise that other materials and services may be costed using a similar method. Further parts may be costed by pressing a further items button 839A. Also the cost of the parts may be saved by pressing a save and hide button 839B. Once the parts have been costed, the price 821 for each work item 820 is updated.

The contractor 130 may also enter a frequency 840 for recurring jobs, for example, but not limited to, daily, weekly, monthly, bi-annually and annually. Depending on the status of the job, a due date 850 may be entered for the job, either a date for completing the job or quoting the job. Using the due date, the job may be automatically scheduled into the contractor's 130 job schedule. The contractor 130 may also indicate when the job has been completed by clicking on a job completed button 860 or alternatively whether each work item 861, 862 has been completed, or an applicable percentage of each work item that has been completed.

Depending on the status of the job, the contractor 130 may either send a quote or send an invoice. The quote may be sent to the customer 140 by clicking on a send quote button 870. If the job has been completed, a send invoice button 880 will be visible in order that the contractor 130 can send an invoice to the customer 140.

Depending on preferences established by the customer 140, the quote(s) and/or invoice(s) provided by contractor(s) may also be automatically forwarded to other parties associated with the property, such as the property manager, line manager or property owner (who may or may not be the customer who initiated the job).

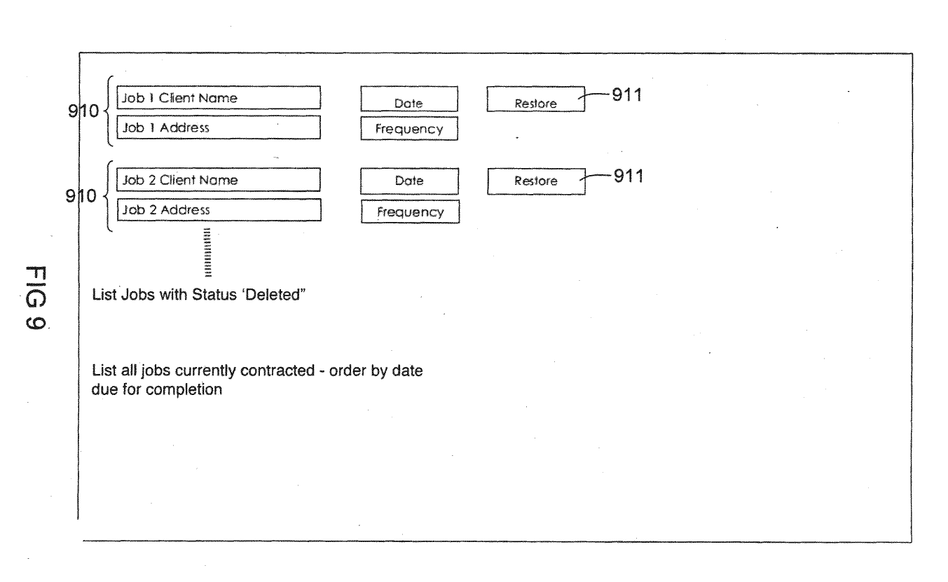

The contractor 130 may recover jobs that have been previously deleted from the contractor's 130 account. FIG. 9 is a screenshot 900 of a job recovery webpage according to an embodiment of the present invention. The job recovery webpage shows a list of deleted jobs 910. Each deleted job 910 may show a short description of the job. In order to restore the job, the contractor 130 may click on a respective restore button 911.

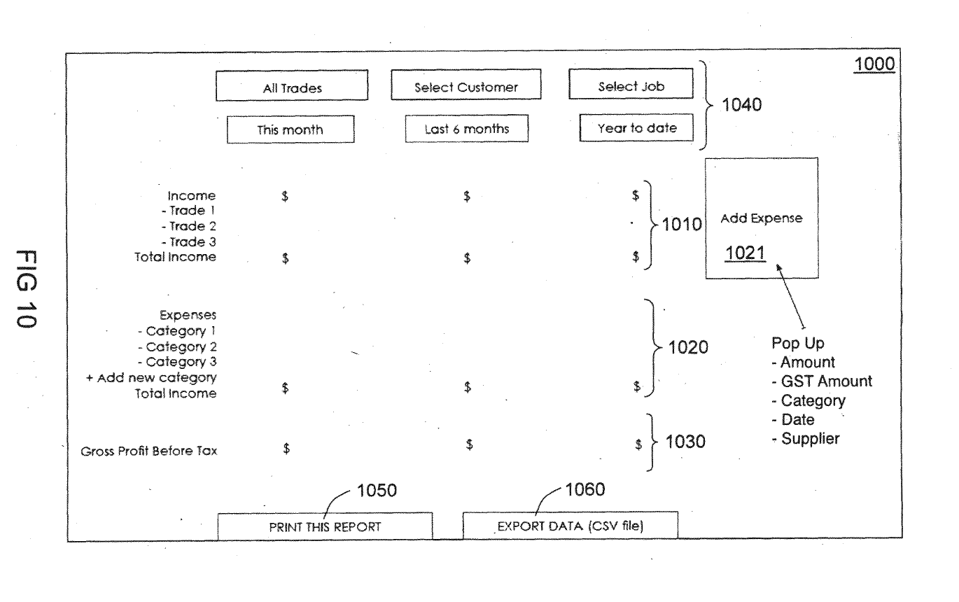

When the book keeping button 640 of FIG. 6 is pressed, the contractor may view a profit and loss statement. FIG. 10 is a screenshot 1000 of a profit and loss webpage according to an embodiment of the present invention. The profit and loss webpage may include income 1010, expenses 1020 and profit 1030. The profit and loss may be displayed according to criteria 1040 such as a trade, a customer, and a time period, such as a month, 6 months or a year. In addition, the contractor 130 may add an expense by clicking on an add expense button 1021, or any other suitable field. The contractor 130 may also import details of expenses by pressing a button which will cause the server to access details of transactions recorded by the contractor's 130 financial institution. Furthermore, the statement may be printed by clicking on a print button 1050 or the statement may be exported to a chosen file format by clicking on an export button 1060.

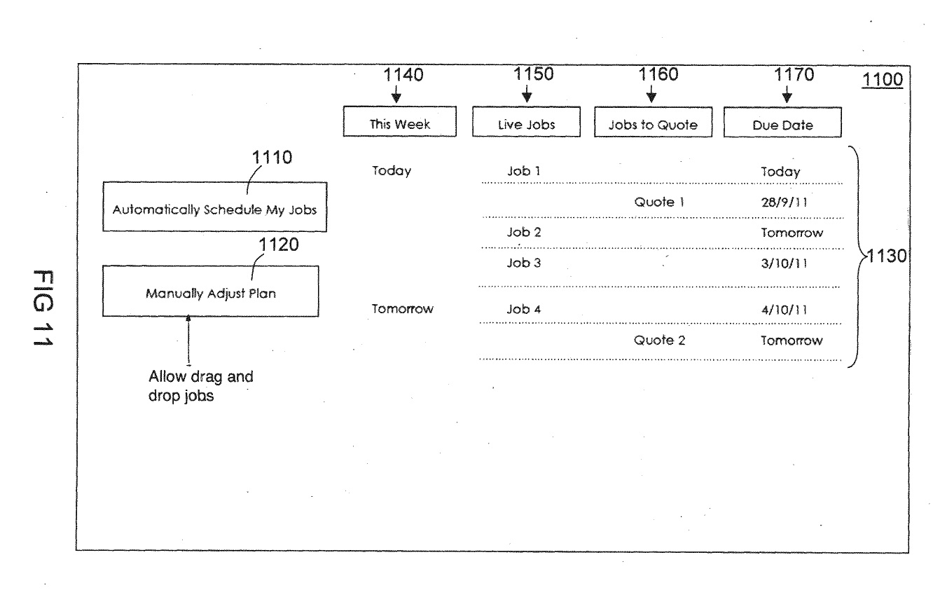

The present invention also allows the jobs to be scheduled. FIG. 11 is a screenshot 1100 of a scheduling webpage according to an embodiment of the present invention. In order to automatically schedule jobs, the contractor 130 clicks on an automatic schedule button 1110. The server 120 analyses the jobs according certain criteria, such as a distance between each job, a time to complete a job, a due date and a geographical area, and creates the schedule.

Once the server 120 has scheduled the jobs, a list 1130 is displayed to the contractor 130 of the jobs. The list 1130 may show a date 1140, a description 1150, 1160 of the job and a due date 1170 of the job. The contractor 130 may manually adjust the schedule by dragging and dropping jobs in the list. Furthermore, the schedule for a particular day may be displayed on the map of FIG. 6.

Using a web browser, a customer 140 may search for a suitable contractor 130 by using the system 100 of the present invention.

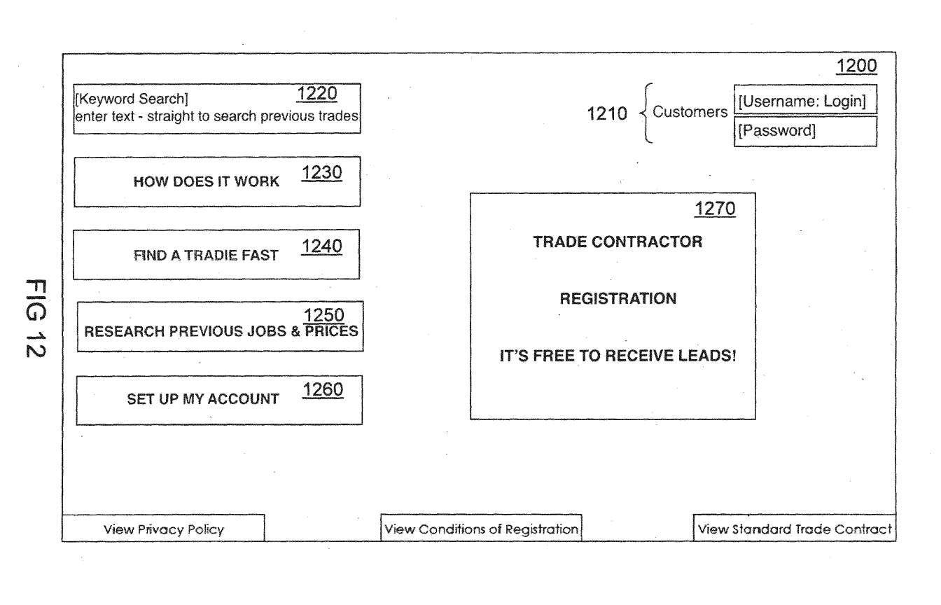

FIG. 12 is a screenshot 1200 of a home webpage according to an embodiment of the present invention. The home webpage allows a customer to login by providing a user name and password 1210. If a customer 140 has not registered the customer 140 may register by clicking on a customer registration button 1260. However a customer may perform a keyword search for previous jobs by entering search terms into a search box 1220.

The customer 140 may view a description and a flow chart of how the website works by clicking on an information button 1230, and perform a detailed search by clicking on a find “tradie” button 1240. The customer 140 may research previous prices for jobs that have been contracted via the website for a particular trade at a particular location by clicking on a research button 1250.

Furthermore, a contractor 130 may register to receive leads from prospective customers, by pressing a contractor button 1270 and the contractor 130 enters their details using the webpage of FIG. 3.

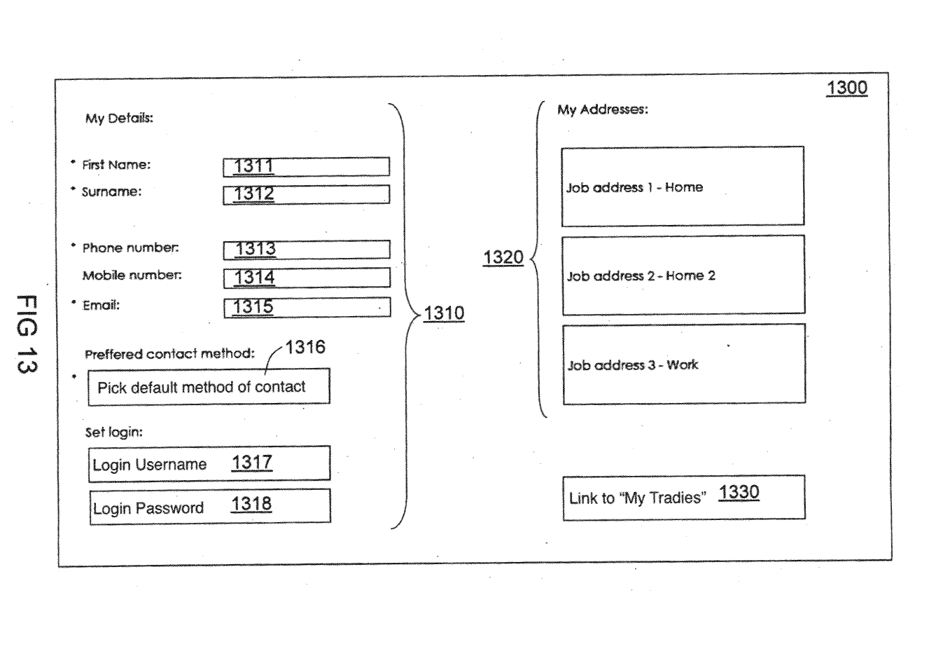

In order to register, a customer 140 enters customer data. FIG. 13 is a screenshot 1300 of a customer data webpage according to an, embodiment of the present invention. The customer data may include customer contact details 1310 such as a first name 1311, a surname 1312, a phone number 1313, a mobile phone number 1314, an email address 1315, a preferred contact method 1316 such as by phone or email and a username 1317 and password 1318.

Similarly, corporate customers, such as property managers, may establish numerous linked accounts for staff and management. Staff and manager accounts may be established with appropriate permissions with respect to placing orders for works with contractor(s) 130 (not shown in this embodiment). Furthermore, the customer 140 may enter a plurality of default job locations 1330 such as a home address, a holiday home address or a business address. Similarly, a corporate customer may enter numerous addresses that they own or manage.

The customer 140 may also enter numerous contact details for parties associated with a property, such as property owner, line manager, builder or property occupant/tenant (not shown in current embodiment). The customer 140 may also identify default types of communication that may be automatically provided to each party, such as ‘forward all quotes’ or ‘forward invoices’ or ‘send entry notice prior to contractor access to property’ (not shown in current embodiment).

Once the customer 140 has entered the customer data, the customer data is transmitted to and stored on the server 120 in a database. In addition, the customer may view contractors 130 that the customer 140 has previously used by clicking on a previous contractor 130 button 1130.

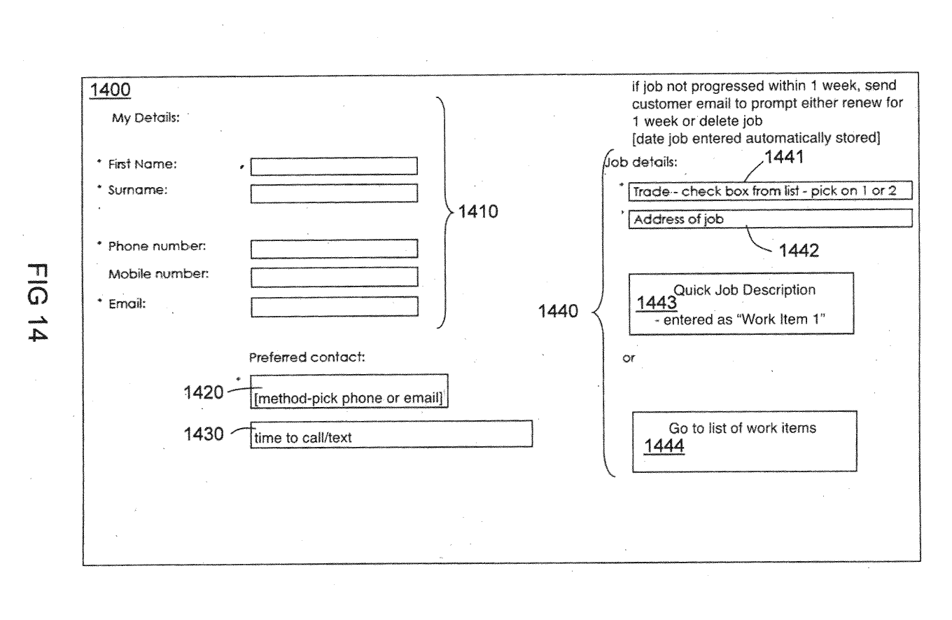

In order to find a contractor 130, the customer 140 completes a search webpage. FIG. 14 is a screenshot 1400 of a search webpage according to an embodiment of the present invention. Firstly, the customer 140 enters customer data 1410 such as a name, address and contact details. The customer data 1410 may be automatically populated from the customer data entered in the webpage of FIG. 13. Alternatively, if the customer 140 has not registered, a customer account is created from the customer data. Similarly to FIG. 13, the customer 140 selects a preferred contact method 1420 and time 1430.

The customer 140 also enters job details 1440. The job details 1440 may include a trade 1441 (for example a gardener), an address 1442 of where the job is to take place and a brief description of the job 1443, for example mowing a lawn. Alternatively, the customer 140 may enter a number of work items which together form a description of the job 1444.

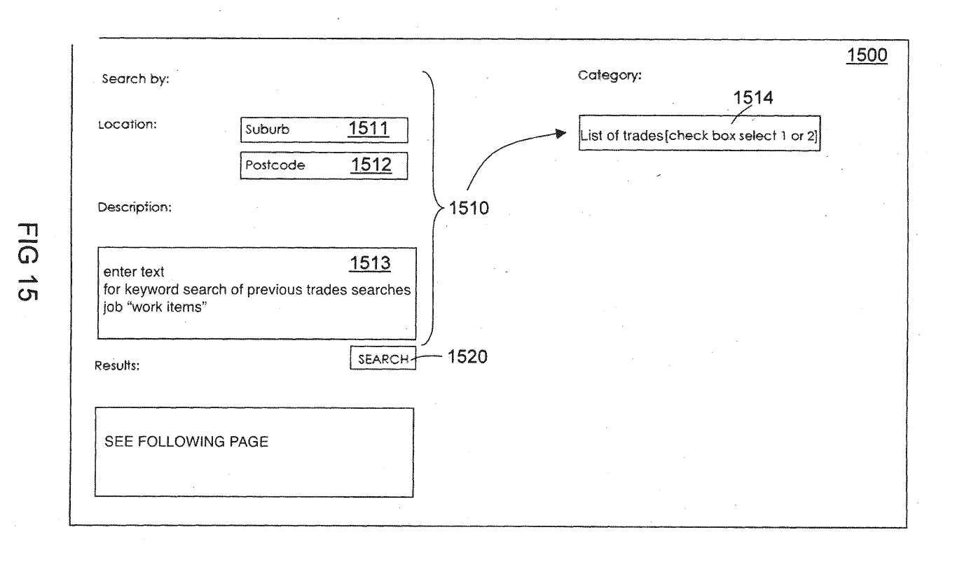

In addition, the customer 140 may research previous job descriptions and prices by using a previous job search page; FIG. 15 shows a screenshot of a previous job search webpage according to an embodiment of the present invention. In order to research previous jobs, the customer 140 enters search criteria 1510. The search criteria may include a suburb 1511 and/or postcode 1512, a brief description 1513 of the work, and a type of trade 1514 (for example an electrician). The customer 140 then presses a search button 1520 in order to initiate the search. The search criteria 1510 are transmitted to the server 120 and the server searches for the most relevant previous job descriptions, and then returns the most relevant previous jobs to the customer 140.

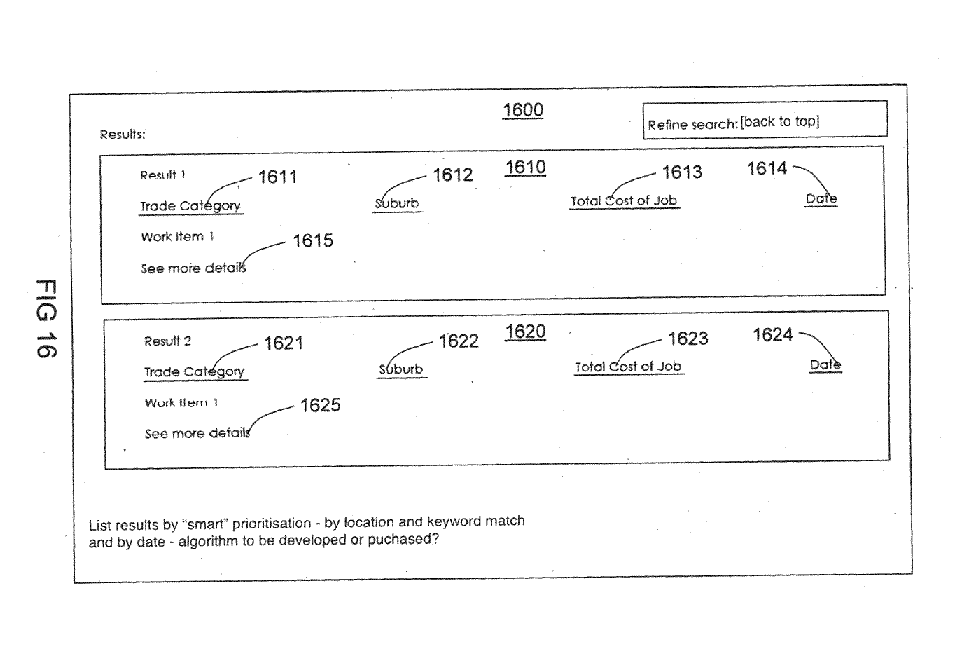

FIG. 16 is a screenshot 1600 of a search results webpage according to an embodiment of the present invention. In the present example, two previous jobs have been found by the server 120 to be most relevant to the search criteria entered in FIG. 15. Previous job details 1610, 1620 are then sent to the customer 140. The previous job details may include a trade 1611, 1621, a suburb 1612, 1622 where the job was performed, a cost of the job 1623, a date 1624 the job was performed and a rating provided by the customer 140 of the job. The customer 140 may view more information pertaining to the previous job by clicking on a more details button 1615, 1625 to show details of work items relevant to the previous job.

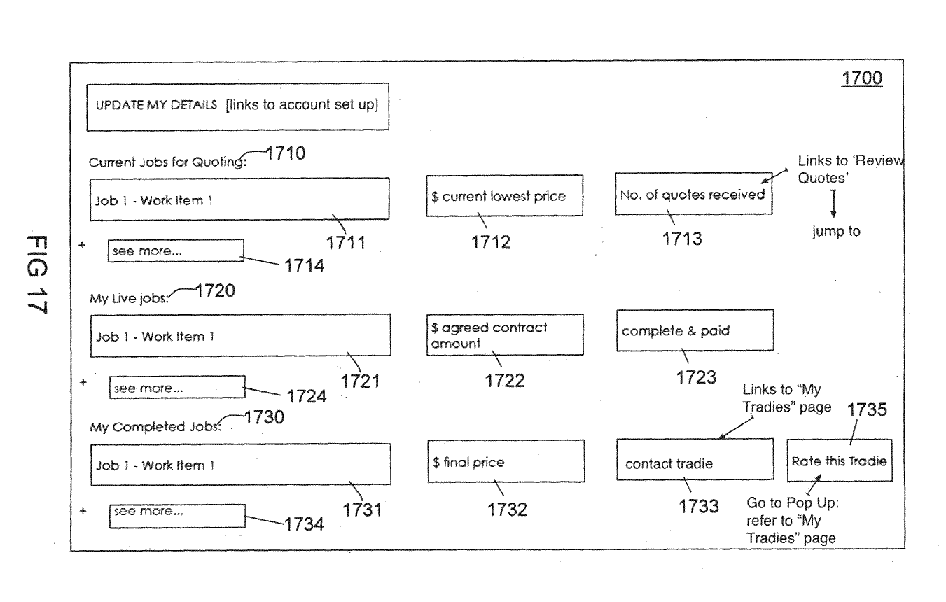

Once a customer 140 has logged in, the customer 140 may view existing jobs and quotes on the customer 140 account. FIG. 17 is a screenshot 1700 of a customer jobs webpage according to an embodiment of the present invention. The customer jobs webpage includes a list of quotes 1710, live jobs 1720 and completed jobs 1730.

The list of quotes 1710 may be listed according to, but not limited to, a job description 1711, a current lowest price 1712, and a number of quotes received 1713. Each time a quote is received, the server 120 compares the quote with other quotes received to determine the lowest price received. The customer 130 may display further details relevant to each quote 1710 by clicking on a see more button 1714 which displays a list of each work item for the job, including any amendments made to work item descriptions by the contractor 130 providing the quote

Similarly the list of live jobs 1720 may be listed according to a job description 1721, an agreed price 1722, and a status 1723 of the job. The status 1723 may detail whether the job is yet to be quoted, the job is yet to be done, has been completed and whether the invoice has been paid. The customer 130 may display further details pertaining to each live job by clicking on a see more button 1724.

The completed jobs 1730 may be listed according to a job description 1731 and a final price 1732 or cost of the job. Furthermore, the customer 140 may contact the contractor by clicking on a contact “tradie” button 1733 and also allows the customer 140 to provide a rating 1735 for the contractor 130. The customer 130 may display further details of each completed job by clicking on a see more button 1734 to display the work items pertaining to that job.

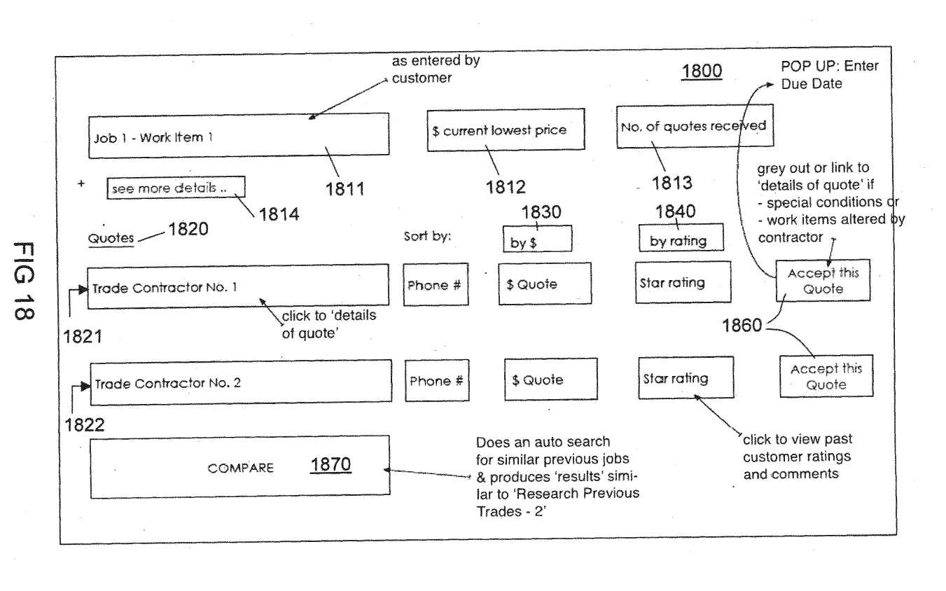

The customer 140 may also review quotes received for a job. FIG. 18 is a screenshot 1800 of a quote review webpage according to an embodiment of the present invention. Similar to FIG. 17, the quote review webpage shows a job description 1811, a current lowest quote 1812 and a number of quotes received 1813. Furthermore, the quote review webpage shows a list of quotes 1820, including a first and a second quote 1821, 1822. The customer 140 may arrange the quotes 1820 according to a quoted price 1830 or a rating 1840. In order to accept either the first or second quote 1821, 1822, the customer 140 may click on an accept quote button 1860 causing the job status to be automatically updated on the server 120 and an email to be sent to the contractor 130. In addition, the customer 140 may view prices of similar jobs performed by contractors by clicking on a compare button 1870.

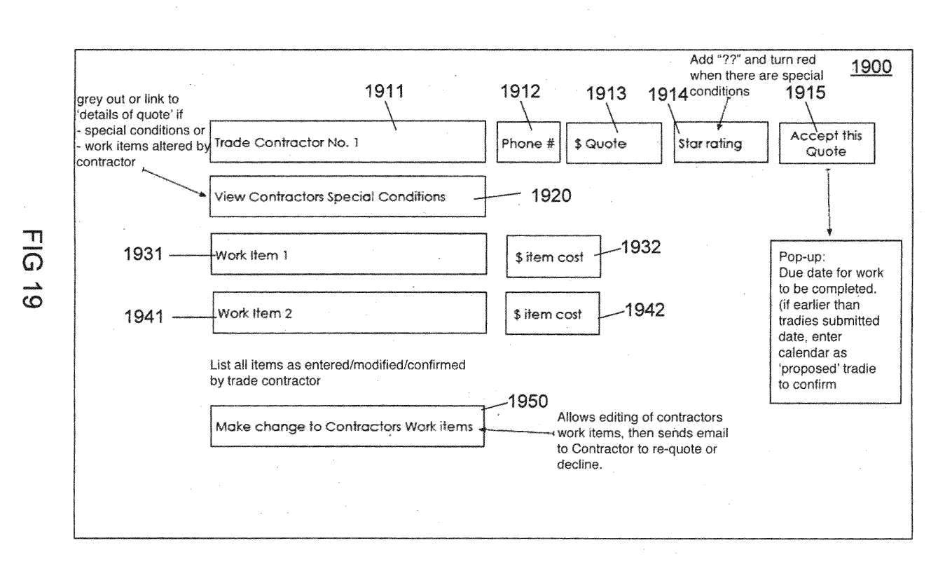

From the quote review webpage of FIG. 18, the customer 140 may click on a quote in order to view details of the quote. FIG. 19 is a screenshot 1900 of a quote details webpage according to an embodiment of the present invention. The quote details webpage may include a contractor name 1911, a contractor phone number 1912, a quote 1913 for the job, and a rating 1914 of the contractor 130. The customer 140 may accept the quote by clicking on an accept button 1915. The quote details may also show any special conditions 1920 that the contractor 130 may have imposed on the job. Furthermore, the quote details may detail each work item of the job 1931, 1941 and a price 1932, 1942 for each work item of the job. For example for a gardening or landscaping job the work items may include “mow lawn” and “trim lawn edges”. The customer 140 may also amend any details of the job, for example any requirements such as “please also prune the roses” by clicking on an amend button 1950.

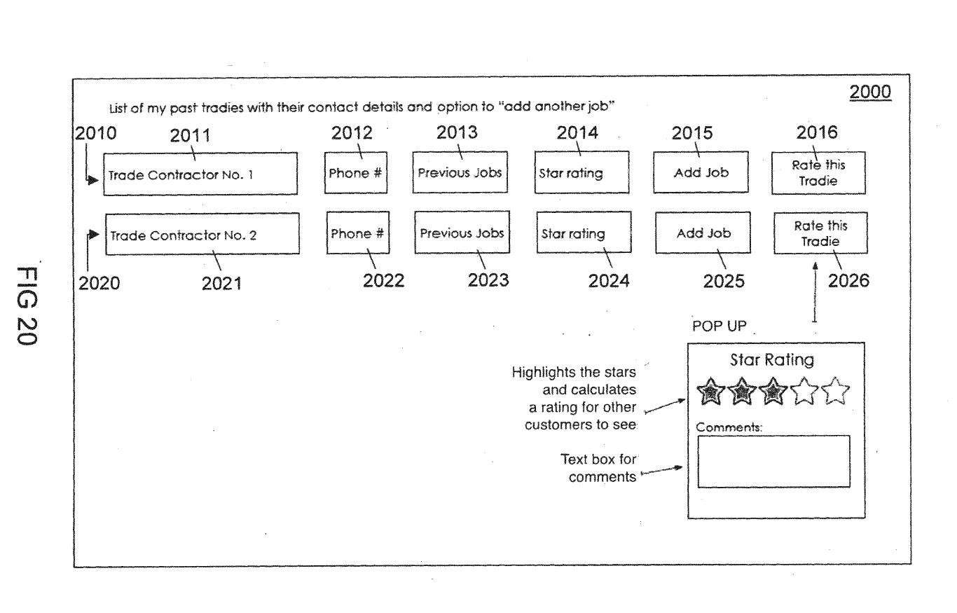

The customer 140 may also view contractors that the customer 140 has previously engaged. FIG. 20 is a screenshot 2000 of a previous contractors webpage according to an embodiment of the present invention. The previous contractors webpage shows a list of previous contractors 2010, 2020 that have been engaged by the customer 140. The list may also detail a name 2011, 2021 of the contractor 130, a phone number 2012, 2022 of the contractor 130, a description of a previous job or jobs 2013, 2023 performed by the contractor 130, and a star rating 2014, 2024 of the contractor 130. In addition, the contractor 130 may request a new quote from the contractor 130 by clicking on an add job button 2015, 2025, or provide a rating 2016, 2026 if the customer 140 has yet to provide a rating for the job performed by the contractor 130.

Whilst the contractor 130 is mobile, such as on the road, the contractor 130 may use a smartphone or similar device to perform quotes and send invoices using templates that were created using the template webpage of FIG. 5 as previously described. Furthermore, the contractor 130 may also perform other job administration tasks such as delete jobs and re-schedule jobs.

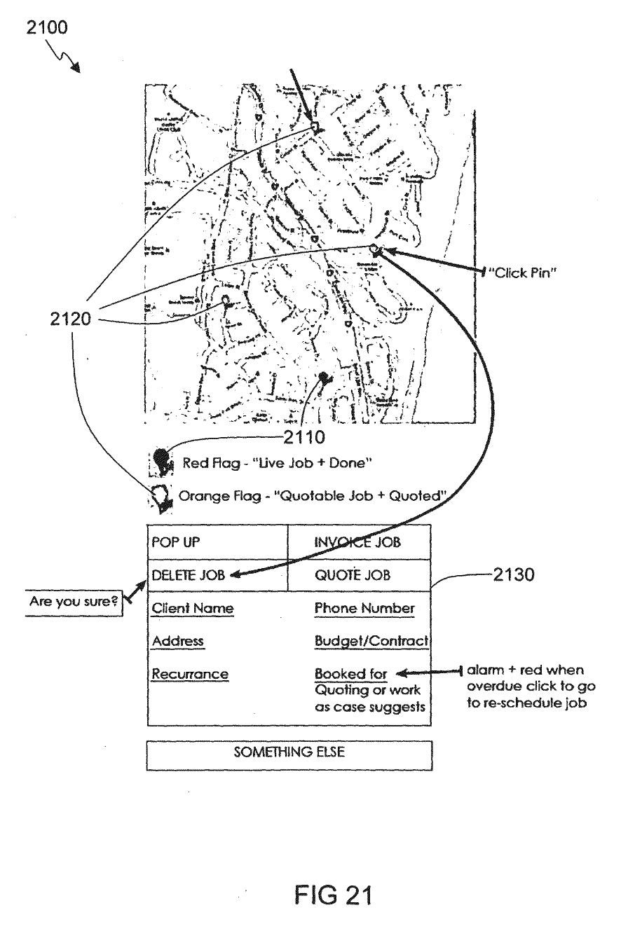

FIG. 21 is a screenshot 2100 of a job overview webpage according to an embodiment of the present invention. The contractor 130 may view all jobs according to their location and status on a map. Similar to the map shown in FIG. 6, each job is shown according to a coloured marker. In one embodiment, live and completed jobs are shown as red markers 2110 and quoted and quotable jobs are shown as orange markers 2120. It should be appreciated that any applicable marker may be used and that live, completed, quoted and quotable jobs may be shown by individual markers.

In order to view details of the job, the contractor 130 presses an applicable marker 2110, 2120 and a table 2130 is displayed showing the job details. The job details may include a customer name, an address, a phone number, a budget, a recurrence of the job for example weekly, monthly, and a status of the job, for example whether the job has been booked for quoting, quoted, a live job or a completed job. Depending on the status, the contractor 130 may click on a button to quote the job, delete the job or invoice the job.

As previously described, when a contractor 30 arrives at a location for quoting or performing a job, the smartphone displays a prompt to the contractor 130 to either prepare a quote for the job or to prepare an invoice for the job depending on a status of the job. If the status of the job is a request for quotation, the contractor 130 is prompted to prepare a quote. If the status is live job, the contractor 130 is prompted to prepare an invoice.

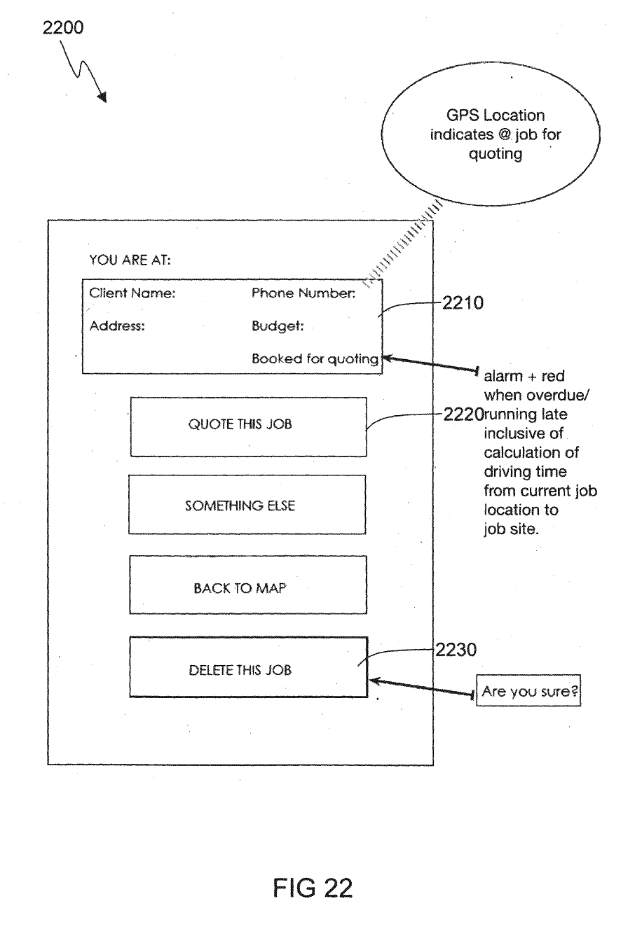

FIG. 22 is a screenshot 2200 of a quote prompt webpage according to an embodiment of the present invention. As previously mentioned, the quote prompt webpage is displayed to the contractor 130 when the contractor 130 is at or near to the location of the job when the status of the job is a request for quotation. The quote webpage includes job details 2210 such as a customer name, a customer address, a customer phone number, a budget and a time for performing the quote. In order to perform the quote, the contractor 130 clicks on a quote button 2220. Additionally, the contractor may delete the job by clicking on a delete button 2230, or may view the map of the job overview webpage of FIG. 21 by pressing a map button 2240.

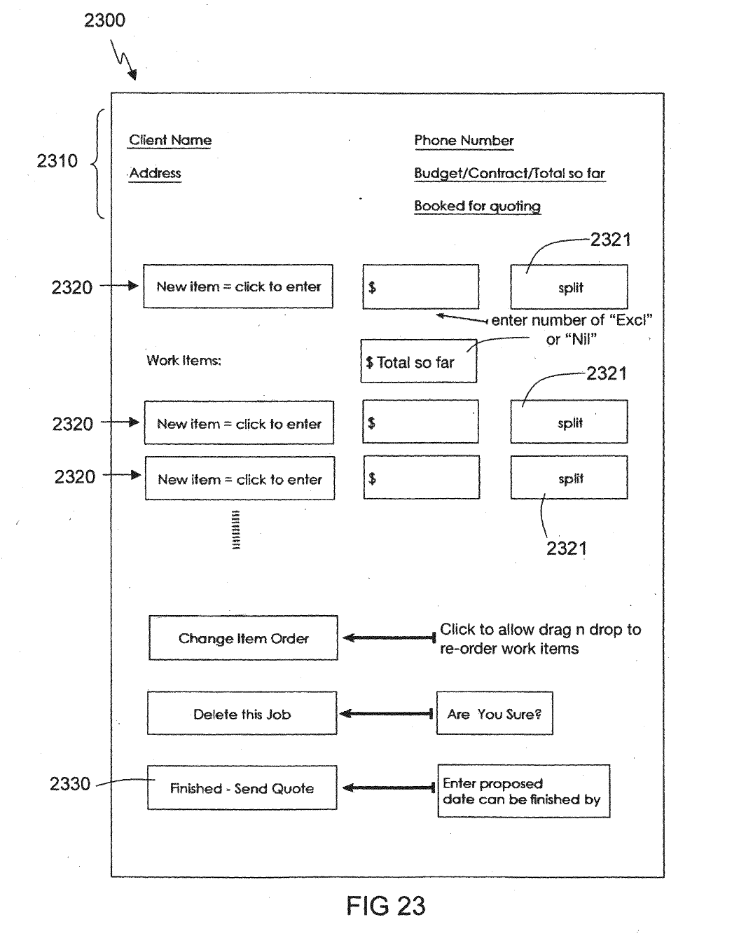

By clicking on the quote button 2220 of FIG. 22, the contractor 130 is presented with a quote template. FIG. 23 shows a screenshot 2300 of a quote template webpage according to an embodiment of the present invention. The quote template webpage includes client details 2310 and one or more work items 2320. For example the work items 2320 may be “mow lawn” and “trim edges of lawn”. The quote template may detail a cost for each work item and a total cost for the job. Once the contractor 130 has completed entering each work item, the quote is saved to the server 120, and may also be sent to the customer 140 by email by clicking on a send quote button 2330.

It should also be appreciated that the contractor 130 may manually add quotes by entering the customer and job details directly, rather than the details being received from a request for quotation. Furthermore, an address of the job may be acquired from the GPS co-ordinates obtained from the smartphone and the address automatically updated.

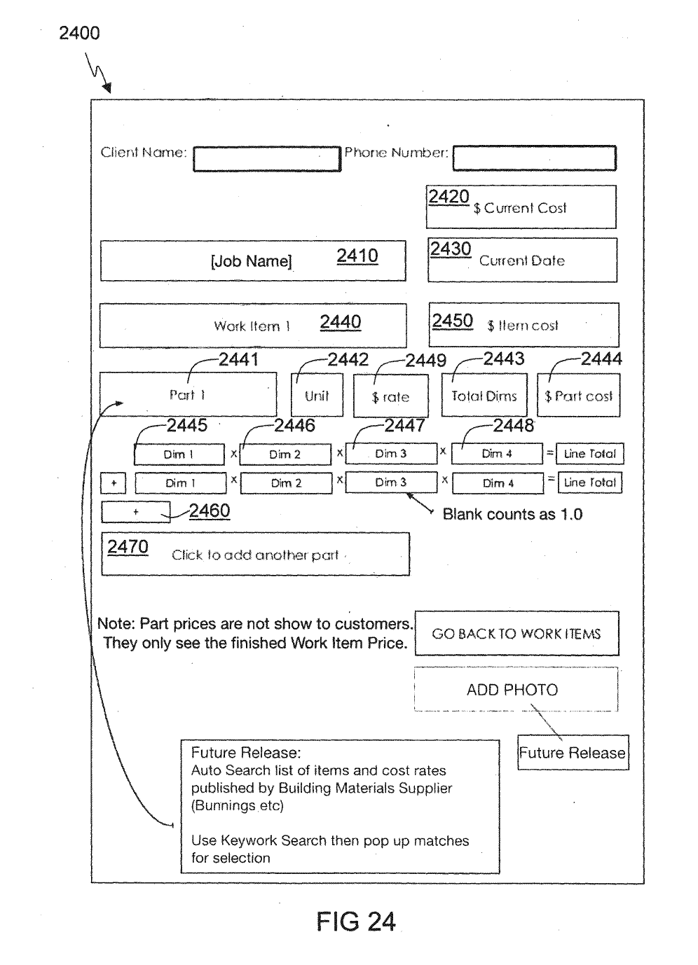

Similarly to the webpage of FIG. 8, for each work item the contractor 130 may cost parts or subcontractors required for the job. For example, the contractor 130 may require gyprock in order to build a partition wall. In order to cost parts required for a job, the contractor 130 clicks on a split button 2321 in order to view a parts webpage. FIG. 24 is a screenshot 2400 of a parts webpage according to an embodiment of the present invention. The parts webpage shows a job name 2410, a current cost of the job 2420, a date 2430 of the job, a description of the work item 2440, a description of a part 2441, a unit of measurement 2442 for the part, a total dimension 2443 of the part, a part cost 2444, a first dimension 2445, a second dimension 2446, a third dimension 2447, a fourth dimension 2448 and a rate 2449. From the dimensions 2445, 2446, 2447, 2448, the server 120 (or the smartphone) may determine the total dimension 2443. For example, the part may be costed according to an area. Thus the unit of measurement may be in metres squared and only the first and second dimensions 2445, 2446 need to be entered and the third and fourth dimensions 2447, 2448 default to 1. Further dimensions may be added by clicking on button. From the area, the server 120 (or the smartphone) may calculate a cost of the gyprock according to an area that is required. The rate 2449 may be a cost per hour should a subcontractor be required. A person skilled in the art will realise that other materials and services may be costed using a similar method. Further items may be costed by pressing a further items button 2470. The total cost 2450 is the total cost of all items for the work item.

In the current embodiment, the cost of parts is not displayed to a customer 140, rather a total cost to perform the job may be seen by the customer 140. Furthermore, a margin may be applied to the cost of any parts obtained from a supplier.

In a further embodiment, the server 120 may determine costs of materials and parts in real time by obtaining costs for materials and parts from supplier databases either downloaded into the smartphone memory or stored on the server.

Once the contractor 130 has completed a quote and the quote is accepted by the customer 140, the job is scheduled, and thus the status is “live job”. When the contractor 130 arrives at the location, a prompt is received on the smartphone to complete and send an invoice.

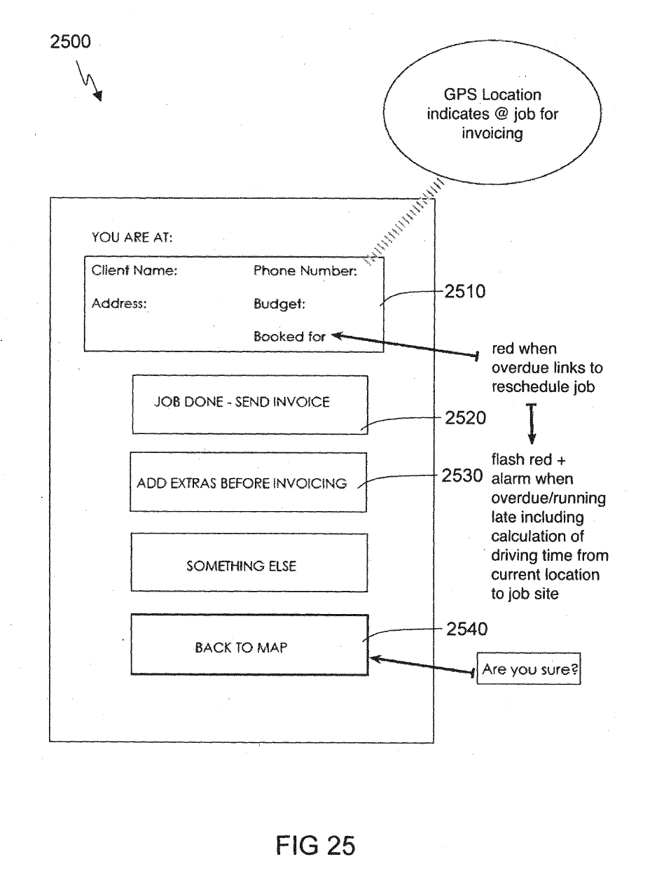

FIG. 25 is a screenshot 2500 of an invoice webpage according to an embodiment of the present invention. Similar to the webpage of FIG. 22, the invoice webpage includes customer details 2510. In order to send an invoice to the customer 140, the contractor 130 clicks on a send invoice button 2520. If the contractor 130 has performed extra work, the contractor 130 may edit the quote by clicking on an add extras button 2530. Extras may include the addition of hedge trimming requested by the customer 140 whilst the contractor 130 was on site.

In order to view a map showing all current jobs, the contractor clicks on a map button 2540.

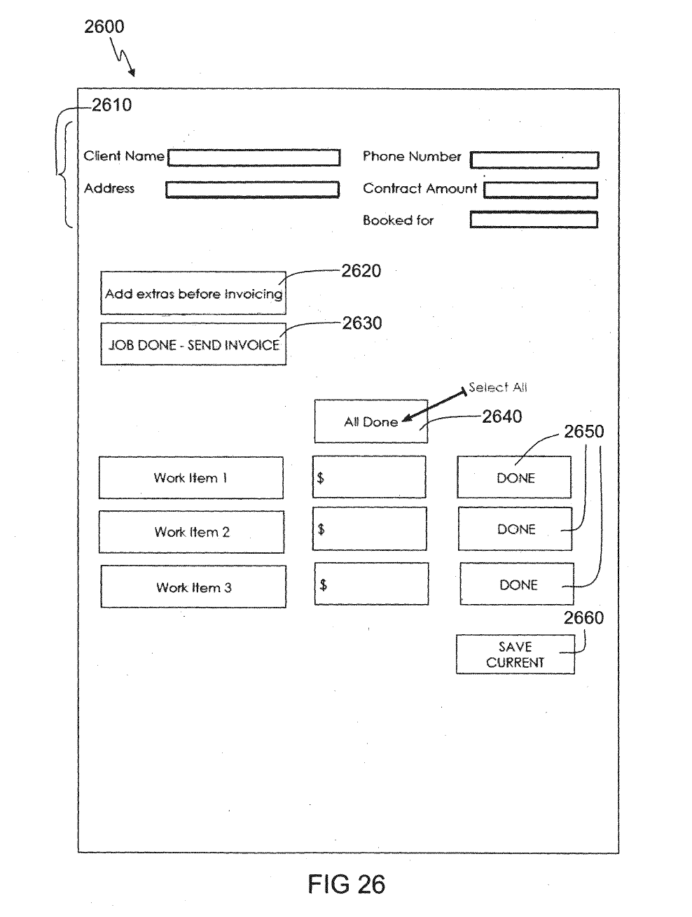

Before sending the invoice the contractor 130 may review the invoice. FIG. 26 is a screenshot 2600 of a review invoice webpage according to an embodiment of the present invention. The review invoice webpage includes customer details 2610, such as a name, an address, a phone number and an accepted quote amount. The contractor 130 may add extra work items by clicking on an extras button 2620 and send the invoice by clicking a send invoice button 2630. Furthermore, the contractor 130 may choose to invoice all work items by clicking on an all done button 2640 or the contractor may choose to only invoice certain work items by clicking on a respective done button 2650 relating to a specific work item. The contractor 130 may save the invoice by clicking on a save button 2660.

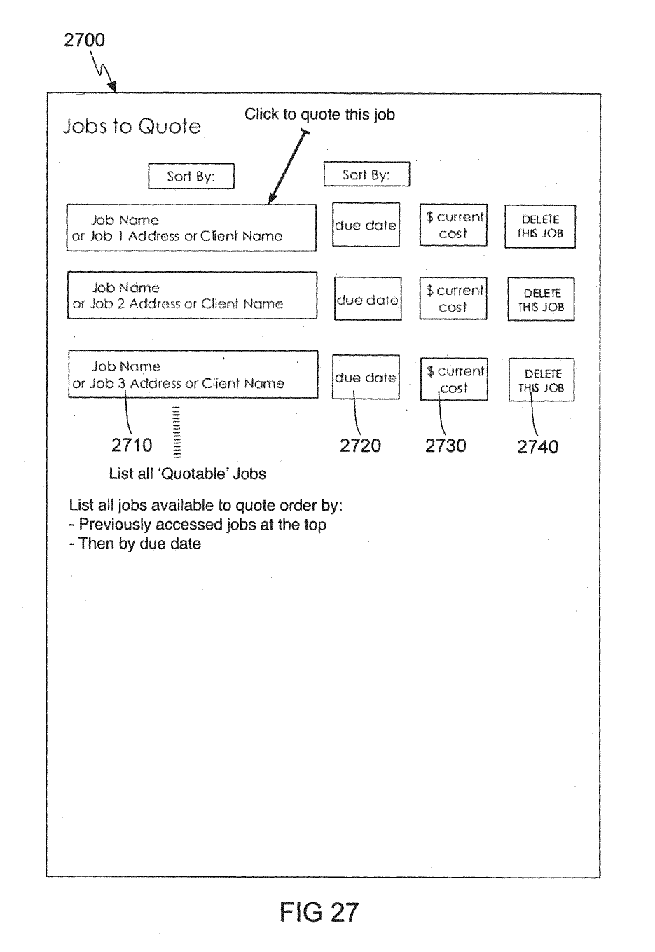

Similar to the webpage of FIG. 7, the contractor 130 may view a list of jobs for quoting. FIG. 27 is a screenshot 2700 of a list of jobs for quoting webpage according to an embodiment of the present invention. The list may be displayed according fields such as a job name and a client name and address 2710, a due date 2720, and a current cost 2730. The contractor 130 may delete a job by clicking on a delete button 2740. The contractor 130 may sort the jobs according to any of the fields.

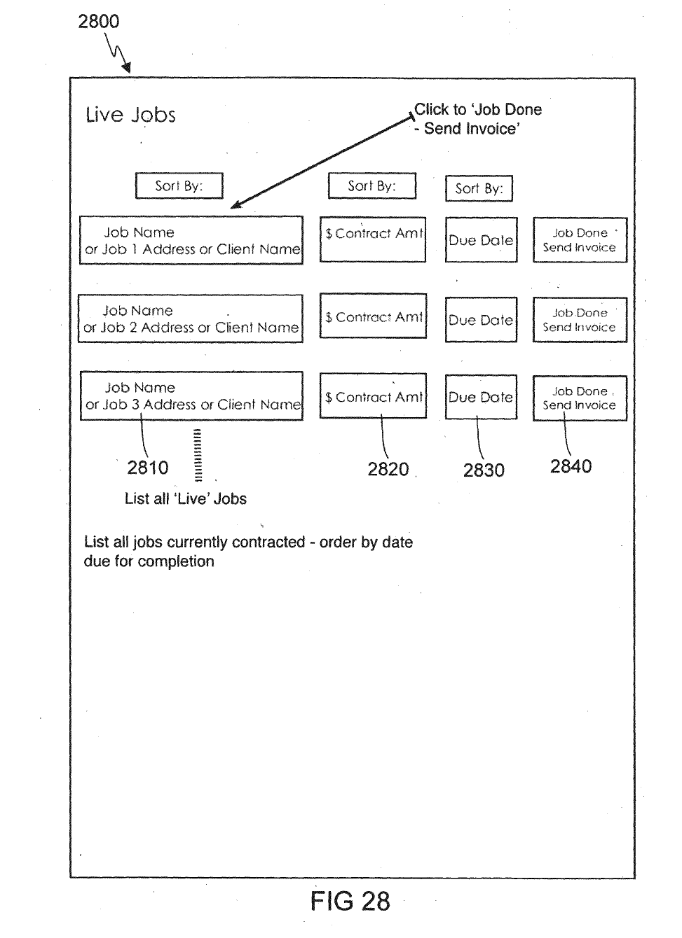

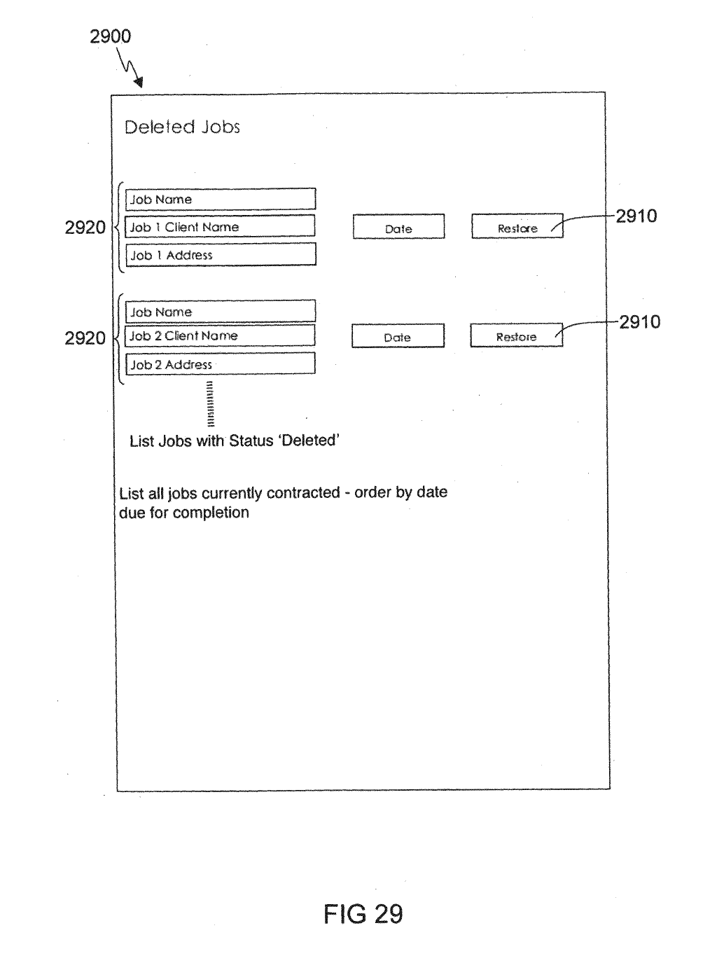

Similarly to FIGS. 7 and 27, the contractor 130 may view a list of live jobs. FIG. 28 is a screenshot 2800 of a list of live jobs according to an embodiment of the present invention. The list of live jobs may be listed according to a job name and client name and address 2810, a quoted amount 2820 and a job due date 2830. Furthermore, the contractor 130 may send an invoice according to the quote by clicking on a send invoice button 2640. The contractor 130 may also recover any deleted jobs. FIG. 29 is a screenshot 2900 of a job recovery webpage according to an embodiment of the present invention. As shown in FIG. 29 and similar to FIG. 9, the contractor 130 may recover jobs that have been previously deleted from the contractor's 130 account by clicking on a restore button 2910 corresponding with a respective job 2920.

In summary, some advantages of the present invention include:

1) The customer may obtain quotes from several contractors by entering details of a job only once;

2) The contractor does not need to remember or manually look up any details of a job as the contractor is automatically prompted to perform a task when he or she arrives at a location according to a status of the job;

3) Data may be collected from contractor operatives in the field/at job sites, and automatically stored with other relevant job records which are then accessible both by operatives in the field using mobile computing devices and from the Contractor's office location via computers connected to the internet;

4) Jobs may automatically be scheduled according to a location of the job and a time taken to perform the job;

5) Appropriate notifications can be automatically sent to parties associated with a property, such as an entry notice to advise a building occupant of the intended date for the contractor's works to be undertaken based on the status of the job;

6) Costs of parts/materials may be obtained automatically from retailers;

7) Invoices and quotes may be prepared by the contractor quickly and easily using pre-prepared templates; and

8) Other project administration data may be collected from contractor field operatives and automatically sent to the contractor's office for processing or reported to the customer or other parties, as appropriate.

Although the present invention has been described in relation to contractors such as electricians, plumbers and gardeners, it should be appreciated that the present invention may be applied to any trade or service that is performed at a location such as mobile dog cleaning services and hairdressing services. Also, although the current embodiment reflects primarily collection of cost data (including quotes and invoices), a person skilled in the art of job administration will understand that the system described may also be applied to collect other job specific data from field operatives that is relevant to each phase in the process of the job administration and execution.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A method of estimating, scheduling and administrating a job including the steps of:
receiving a location of a contractor;
determining a status of the job according to the location of the contractor;
sending to the contractor a prompt according to the status of the job;
receiving a response to the prompt from the contractor and storing the response on a server; and
sending the response to a customer for the job.

2. The method of claim 1 wherein the status is one of a request for quotation or a live job, and the prompt is a prompt to complete a quote and a prompt to send an invoice, respectively.

3. The method of claim 1 wherein the prompt is sent from the server to the contractor when the contractor arrives at or near to the location.

4. The method of claim 1 wherein the location includes co-ordinates obtained from a Global Positioning System (GPS).

5. The method of claim 1 wherein the location includes co-ordinates obtained by radio frequency triangulation including cellular triangulation.

6. The method of claim 1 wherein the location includes co-ordinates obtained by reference to available local short-range Wi-Fi networks.

7. The method of claim 1 wherein the location is displayed to the contractor on a map.

8. The method of claim 1 wherein the location is displayed according to the job status.

9. The method of claim 1 wherein the quote is completed from a template.

10. The method of claim 9 wherein the template is created by the contractor and stored on the server.

11. The method of claim 9 wherein the template is created with reference to information generated by the contractor and the customer and stored on the server.

12. The method of claim 2 wherein the quote includes a cost of one or more parts.

13. The method of claim 12 wherein the cost of the part is determined including the steps of:
receiving a description of the part;
sending the description of the part to a retailer;
receiving from the retailer a cost of the part; and
updating the quote with the cost of the part.

14. The method of claim 13 wherein the cost of the part is retrieved from a price list provided by a retailer.

15. The method of claim 1 wherein a schedule of jobs is automatically created according to a time to perform the job and the location of the job, and the schedule is sent to the contractor.

16. The method of claim 15 wherein the schedule is displayed to the contractor on a map.

17. The method of claim 1 wherein the contractor is given a rating by the customer, and the rating for the contractor is stored on the server.

18. A system for estimating, scheduling and administrating a job including:
a server connected to the internet, the server including:
a memory coupled to a processor, wherein the memory includes computer readable program code components configured to cause:
receiving a location of a contractor;
determining a status of the job according to the location of the contractor;
sending to the contractor a prompt according to the status of the job;
receiving a response to the prompt from the contractor and storing the response on the server; and
sending the response to a customer for the job.

19. A mobile computing device for estimating, scheduling and administrating a job including:
a memory coupled to a processor, wherein the memory includes computer readable program code components configured to cause:
receiving a location of a contractor;
determining a status of the job according to the location of the contractor;
sending to the contractor a prompt according to the status of the job;
receiving a response to the prompt from the contractor and storing the response on a server or the mobile computing device; and
sending the response to a customer for the job.
